(19) United States
(12) Patent Application Publication
(10) Pub. No.: US 2026/0353142 A1
(43) Pub. Date: Nov. 5, 2026

(54) TECHNOLOGIES FOR RADIO RESOURCE MANAGEMENT MEASUREMENT PREDICTION

(71) Applicant: Apple Inc., Cupertino, CA (US)

(72) Inventors: Konstantinos Sarrigeorgidis, Los Gatos, CA (US); Jie Cui, San Jose, CA (US); Yang Tang, San Jose, CA (US)

(73) Assignee: Apple Inc., Cupertino, CA (US)

(21) Appl. No.: 19/316,891

(22) Filed: Sep. 2, 2025

(30) Foreign Application Priority Data
May 2, 2025 (GR) 20250100323

(51) Int. Cl. H04W 24/10; H04B 17/318

(52) U.S. Cl. CPC H04W 24/10; H04B 17/328

(57) ABSTRACT

The present application relates to devices and components including apparatuses, systems, and methods for radio resource management (RRM) measurement prediction, including inter-frequency RRM measurement prediction.

### CROSS-REFERENCE TO RELATED APPLICATION

This application claims the benefit of Greece Patent Application Serial No. 20250100323, filed on May 2, 2025, the content of which is incorporated herein by reference in its entirety for all purposes.

### TECHNICAL FIELD

This application relates generally to communication networks and, in particular, to technologies associated with radio resource management measurement prediction.

### BACKGROUND

Third Generation Partnership Project (3GPP) Technical Specifications (TSs) define standards for wireless networks. These TSs describe aspects related to signaling traffic through systems that incorporate wireless networks.

### BRIEF DESCRIPTION OF THE DRAWINGS

FIG. 1 illustrates a network environment in accordance with some embodiments.

FIG. 2 illustrates an example scheme for radio resource management (RRM) prediction across frequency, time, and/or spatial domains, in accordance with some embodiments.

FIG. 3 illustrates an example RRM prediction model in accordance with some embodiments.

FIG. 4 illustrates an example network environment in accordance with some embodiments.

FIG. 5 illustrates another example network environment in accordance with some embodiments.

FIG. 6 illustrates an operational flow/algorithmic structure in accordance with some embodiments.

FIG. 7 illustrates another operational flow/algorithmic structure in accordance with some embodiments.

FIG. 8 illustrates another operational flow/algorithmic structure in accordance with some embodiments.

FIG. 9 illustrates a user equipment in accordance with some embodiments.

FIG. 10 illustrates a network device in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, and techniques in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A/B” and “A or B” mean (A), (B), or (A and B); and the phrase “based on A” means “based at least in part on A,” for example, it could be “based solely on A” or it could be “based in part on A.”

The following is a glossary of terms that may be used in this disclosure.

The term “circuitry” as used herein refers to, is part of, or includes hardware components that are configured to provide the described functionality. The hardware components may include an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), or a digital signal processor (DSP). In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, and network interface cards.

The term “user equipment” or “UE” as used herein refers to a device with radio communication capabilities that may allow a user to access network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, or reconfigurable mobile device. Furthermore, the term “user equipment” or “UE” may include any type of wireless/wired device or any computing device including a wireless communications interface.

The term “computer system” as used herein refers to any type interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component or asset within a computing or network environment, or a physical or virtual component within, accessible by, or available to a device or component. Resources could include, but are not limited to, memory space/usage, processor/CPU time, processor/CPU usage, processor and accelerator loads, hardware time or usage, electrical power, input/output operations, ports or network sockets, channel/link allocations, throughput, or workload units. A “hardware resource” may refer to compute, storage, or networking resources provided by physical hardware elements. A “virtualized resource” may refer to compute, storage, or networking resources provided by virtualization infrastructure to an application, device, or system. The term “communication resource” may refer to resources that are accessible by, or available to, computer devices/systems for transferring information over a channel of a communication network. For example, communication resources may include, but are not limited to, time/frequency resources, code resources, modulation resources, etc. The term “system resources” may refer to any kind of shared entities to provide services, and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, or a virtualized network function.

The term “information element” refers to a structural element containing one or more fields. The term “field” refers to individual contents of an information element, or a data element that contains content. An information element may include one or more additional information elements.

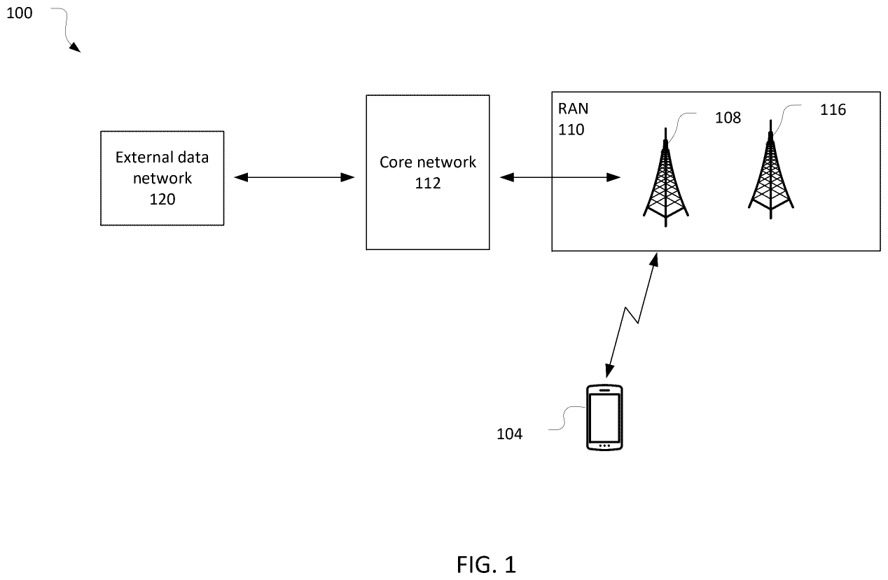

FIG. 1 illustrates a network environment 100 in accordance with some embodiments. The network environment 100 may include user equipment (UE) 104 communicatively coupled with base station 108 of a radio access network (RAN) 110. The UE 104 and the base station 108 may communicate over air interfaces compatible with 3GPP TSs, such as those that define a Fifth Generation (5G) new radio (NR) system or a later system (e.g., Sixth Generation (6G) system). The base station 108 may provide user plane (UP) and control plane (CP) protocol terminations toward the UE 104. In some embodiments, the base station 108 may include one or more transmission-reception points (TRPs) to transmit and/or receive signals to/from the UE 104.

The network environment 100 may further include a core network (CN) 112. For example, the CN 112 may comprise a 5th Generation Core network (5GC), a 6th Generation Core network (6GC), or later generation core network. The CN 112 may be coupled to the base station 108 via a fiber optic or wireless backhaul. The CN 112 may provide functions for the UE 104 via the base station 108. These functions may include managing subscriber profile information, subscriber location, authentication of services, or switching functions for voice and data sessions.

The network environment 100 may further include an external data network 120. External data network 120 may include a system of interconnected nodes that facilitate data transmission between UE 104 and various application servers and other service providers. The base station 108 and the core network 112 may route application data between the UE 104 and external data network 120 or application servers. These application servers host web applications, cloud storage, and multimedia streaming services, which communicate with the UE 104 via standardized protocols and interfaces defined by 3GPP, ensuring secure and efficient data exchange.

Operations described herein as performed by a device (for example, UE 104 or base station 108) may be fully, substantially, or partially performed by processing circuitry implemented on the device. Additionally, operations described herein as performed by “the network” may be performed by a device of the RAN 110 (e.g., base station 108), a device of the core network 112, and/or components thereof.

The UE 104 may perform radio resource management (RRM) measurements on the serving cell and one or more other cells of the RAN 110 (e.g., provided by another base station 116). The other cells may be intra-frequency cells (e.g., in the same frequency carrier as the serving cell) and/or inter-frequency cells (e.g., in a different frequency carrier as the serving cell). The RRM measurements may be performed on one or more reference signals transmitted by the respective cells. The reference signals may include, for example, synchronization signal blocks (SSBs, also referred to as a synchronization signal/physical broadcast channel (PBCH) blocks) and/or channel state information-reference signals (CSI-RSs). In some embodiments, the RRM measurements may be associated with respective transmit beams (e.g., the transmit beam used by the network to transmit the reference signal) and/or receive beams (e.g., the receive beam used by the UE 104 to receive the reference signal).

The RRM measurements may include a reference signal received power (RSRP) and/or another suitable measurement. In some instances, the UE 104 may report the RRM measurements to the RAN 110. The UE 104 and/or RAN 110 may use the RRM measurements for UE mobility (e.g., cell handover and/or beam switching). For example, the UE may perform a cell handover from a source cell to a target cell based on the RRM measurements. Additionally, or alternatively, the RAN 110 may change the transmit beam used to transmit signals to the UE 104 and/or the UE 104 may change the receive beam used to receive signals from the RAN 110 based on the RRM measurements.

Various embodiments herein provide technologies for RRM measurement prediction. For example, the UE may obtain RRM measurements on measurement resources (e.g., CSI-RS resources and/or SSB resources). Individual RRM measurements of the first set of measurements may be associated with a corresponding frequency, cell ID (e.g., within a frequency), transit beam, and/or receive beam. The set of combinations of frequency, cell ID, transmit beam, and/or receive beam for which RRM measurements are obtained may be referred to as a measurement set.

The UE may provide the RRM measurements for the measurement set to an RRM prediction model as an input. The RRM prediction model may output predicted RRM information for a prediction set. The RRM measurements of the prediction set may include RRM measurements associated with different combinations of frequency, cell, transmit beam, and/or receive beam than the RRM measurements for the measurement set. In an example, the predicted RRM information may include predicted RRM measurement values (e.g., RSRP values), such as beam-level measurement values and/or cell-level measurement values. In another example, the predicted RRM information may include ranking information to indicate the best beams and/or cells associated with the prediction set.

Among other potential benefits, the RRM measurement predictions may enable reduced measurement gaps to be used (e.g., since the UE may need to perform fewer measurements). Measurement gaps can occupy significant time/frequency resources and thus have a significant effect on throughput and/or measurement delay. In an illustrative example, in Frequency Range 1 (FR1), the UE may be configured with a 6 millisecond (ms) measurement gap per 40 ms time period, which may occupy 15% of downlink and/or uplink resources and result in a throughput impact of more than 20%. In another illustrative example, in Frequency Range 2 (FR2), the UE may be configured with a 5 ms measurement gap per 20 ms time period, which may occupy 25% of downlink and/or uplink resources and result in a throughput impact of more than 30%. Additionally, there is a measurement delay associated with performing the measurements. In an example, the measurement delay may be equal to 20 ms×24×the number of frequency layers to be measured. The use of an RRM prediction model to predict RRM measurements may enable the measurement gap length (MGL) to be reduced and/or measurement gap repetition period (MGRP) to be increased. This may provide one or more benefits, such as increased communication throughput and/or reduced power consumption.

The RRM measurement predictions across the time domain may enable the SSB measurement timing configuration (SMTC) periodicity to be increased. For example, a typical configuration for the SMTC periodicity may be 20 ms or 40 ms in accordance with current 3GPP specifications. In an example, when an RRM prediction model is used to predict some RRM measurements, the SMTC periodicity may be increased to 160 ms which is the longest periodicity currently supported in the 3GPP specifications. In another example, the 3GPP specifications may be updated to support one or more longer SMTC periodicities that may be used when an RRM prediction model is employed. For example, an RRM scaling factor, K, may be introduced, which is multiplied by the configured SMTC periodicity to determine the actual SMTC periodicity. In an example, K may be 2 or 3 or another suitable value greater than 1. Accordingly, for a configured SMTC periodicity of 160 ms and an RRM scaling factor of 3, the UE may use an SMTC periodicity of 160 ms×3=480 ms for performing RRM measurements. The UE may generate predicted RRM measurements for one or more time periods between the RRM measurements using the RRM prediction model.

As mentioned above, the RRM prediction model may be used to perform spatial RRM prediction, e.g., across transmit beams and/or receive beams. The spatial RRM prediction may provide reduced beam search overhead, e.g., by reducing the need for more frequent beam searches. This may be particularly beneficial in higher frequency communication bands, such as Frequency Range 2 (FR2) and/or mmWave. Additionally, or alternatively, the spatial RRM prediction may reduce the measurement overhead. As discussed above, measurement overhead is significant in current systems (e.g., with SMTC periodicity of 20 ms and an SSB burst of 5 ms in FR2, the related SMTC overhead is 25%). Reduction of the measurement overhead may provide one or more benefits, such as reduced scheduling restrictions (which may result in throughput increase), reduced measurement restrictions, layer 3 (L3)/layer 1 (L1) measurement delay reduction (e.g., by reducing the receive beam sweep set), and/or decrease in the MGL (which may also result in throughput increase).

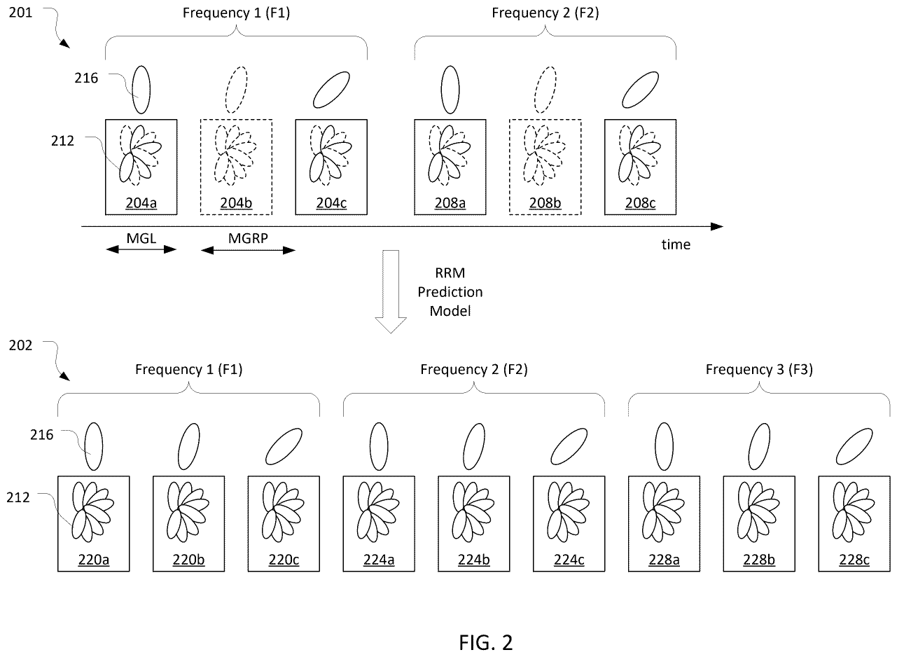

FIG. 2 illustrates an example scheme for RRM prediction across frequency, time, and/or spatial domains, in accordance with some embodiments. The UE may obtain a set of RRM measurements 201 for a measurement set (e.g., including respective combinations of frequencies, cells, transmit beams, and/or receive beams) and generate a set of predicted RRM measurements 202 for a prediction set based on the set of RRM measurements of the measurement set.

For example, for the set of RRM measurements 201, the UE may be configured with measurement gaps 204a-c for a first frequency (F1) and measurement gaps 208a-c for a second frequency (F2). Within the measurement gaps 204a-c and/or 208a-c, the respective base station may transmit reference signals (e.g., SSBs and/or CSI-RSs). In an example, the reference signals may be transmitted with transmit beam sweeping (e.g., with different transmit beams 212). The UE may receive the reference signals with respective receive beams 216. The UE may use different receive beams 216 to receive the reference signals in different measurement gaps 204a-c and/or 208a-c and/or within a given measurement gap.

In an example, the measurements in a given frequency may be performed in a same cell with different transmit beams and/or receive beams and/or across different cells in the same frequency.

The UE may skip measurements in one or more measurement gaps, such as measurement gaps 204b and/or 208b (e.g., enabling the MGRP to be increased). Additionally, or alternatively, the UE may perform measurements on a subset of transmit beams 212 and/or with a subset of receive beams 216 (e.g., enabling the MGL to be decreased). For example, FIG. 2 illustrates measurements of the set of RRM measurements 201 that are performed by the UE in solid lines and illustrates measurements of the set of RRM measurements 201 that are skipped in broken lines. While the additional measurements are shown as being skipped in FIG. 2, in some embodiments, the measurements and/or the associated reference signals may not be configured. The set of respective combinations of cells, frequencies, receive beams, and/or transmit beams on which the UE performs RRM measurements may be referred to as a measurement set. In some embodiments, the UE may receive configuration information from the network to configure the measurement set.

The UE may obtain the set of predicted RRM measurements 202 based on the set of RRM measurements 201 using an RRM prediction model. The set of predicted RRM measurements 202 may include predicted RRM measurements associated with time periods 220a-c on first frequency F1 (e.g., corresponding to measurement gaps 204a-c), time periods 224a-c on second frequency F2 (e.g., corresponding to measurement gaps 208a-c). In some embodiments, the set of predicted RRM measurements 202 may further include predicted RRM measurements associated with another frequency (e.g., third frequency F3) that is not included in the set of RRM measurements 201. For example, the set of predicted RRM measurements 202 may include predicted RRM measurements associated with time periods 228a-c on third frequency F3. In some embodiments, the time periods associated with predicted RRM measurements 202 may overlap (e.g., be associated with the same time).

The set of predicted RRM measurements 202 may include predicted RRM measurements for additional transmit beams 212 and/or receive beams 216 that were not included in the set of RRM measurements 201. Accordingly, the set of predicted RRM measurements 202 may provide a complete set of RRM measurements across combinations of frequencies, cells, receive beams, and/or transmit beams of the prediction set. In an example, the UE may receive configuration information from the network to configure parameters of the prediction set (e.g., a number of frequencies, cells, receive beams, and/or transmit beams to include, and/or other parameters).

In some embodiments, the predicted RRM measurements 202 may enable the MGL of the measurement gaps 204a-c and/or 208a-c to be reduced, e.g., to reduced transmit beam sweeping. In one example, the MGL may be reduced from 5 ms to 3 ms. In another example, the MGRP may be increased. Furthermore, the UE may not be configured with measurement gaps for all frequencies of the prediction set (e.g., for frequency F3 in the example of FIG. 2).

In an illustrative example, the measurement overhead may be approximated by (#of MGs)×(MGL)/(Total time period). The total time period may be approximated by (# of MGs−1)×(MGRP). For a reference scenario of performing measurements in 9 measurement gaps with an MGL of 5 ms and an MGRP of 20 ms, the overhead may be 9×5/(8×20)=28%. For a second scenario with the number of measurement gaps reduced to 4 over the same time period and the MGL reduced to 3 ms, the overhead may be 4×3/160=7%. This reduction in overhead may result in a throughput increase of about 29%.

In embodiments, training data may be collected from a plurality of locations (e.g., from respective UEs) within a geographic area. The training data may be associated with one or more frequency layers. For example, the input data for a source UE i (e.g., corresponding to a location) and a frequency layer k may include RRM measurements for Nₖ respective cells in the frequency layer k (also referred to as transmission sites within the geographic area). Accordingly, the input data for source UE i and Nₖ cells in frequency layer k may correspond to vector xᵢ (xᵢ₁, xᵢ₂, . . . , x_{iNk}). The input data may further include additional input data samples for other locations (and/or from other UEs), such as xⱼ (xⱼ₁, xⱼ₂, . . . , x_{jNk}). Input samples from different locations (e.g., xᵢ and xⱼ) may be correlated due to spatial consistency.

The target output data may correspond to RRM measurements for a second frequency layer m (e.g., including Nm cells/sites). Accordingly, the target data for source UE i may correspond to yᵢ (yᵢ₁, yᵢ₂, . . . , y_{iNk}) and for source UE j may correspond to yⱼ (yⱼ₁, yⱼ₂, . . . , y_{jNk}). Samples yᵢ and yⱼ may be correlated due to spatial consistency.

The input data xⱼ may correspond to

$${x}_{i} ( {PL}_{k} ( {F}_{k} , {l}_{x i} , {l}_{y i} ) , {SSF}_{i [ 1 : {N}_{k} ]}^{k} )$$

and the output data yᵢ may correspond to

$${y}_{i} ( {PL}_{m} ( {F}_{m} , {l}_{x i} , {l}_{y i} , Δ {l}_{x} {l}_{{y}_{i [ 1 : {N}_{m} ]}} ) , {SSF}_{i [ 1 : {N}_{m} ]}^{m} ) ,$$

where PL corresponds to a pathloss function based on frequency F and location coordinates lₓ and l_{y} (e.g., corresponding to x and y coordinates in the geographical area) and SSF corresponds to small-scale fading.

Accordingly, a training data set may correspond to an input data set X of data samples associated with cells in a first frequency at respective reference locations and output data set Y of data samples associated with cells in a second frequency at respective reference locations. The training data may be used to train an RRM prediction model (e.g., an AI/ML model) for predicting RRM measurements in a second frequency based on one or more RRM measurements in a first frequency.

In some embodiments, the training data for a given frequency layer may correspond to the best beam (e.g., the beam with the greatest RSRP) for the respective cells. Accordingly, the training data for a given frequency layer may be a vector with an RSRP value for each cell. In other embodiments, the training data may include measurement values for multiple beams (e.g., transmit beams and/or receive beams) for a respective cell. Accordingly, the training data for the cells of a given frequency layer may be a matrix with measurement values for multiple beams for individual cells.

In some embodiments, the input training data may additionally or alternatively include assistance information and/or other information, such as a precoding matrix indicator (PMI), transmit beam indices, and/or codebook information for respective cells (e.g., associated with respective cell IDs). The codebook information may include, for example, a number of beams, beam widths, order of beams, etc.

Accordingly, a fingerprint database may be generated that includes RRM measurement data for different locations in a geographical area. The RRM measurement data may be associated with respective cells, frequencies, transmit beams, and/or receive beams. For example, reference measurements may be obtained at a set of location reference points lᵢ(lₓ, l_{y}) which may correspond to location coordinates. Reference fingerprints (e.g., a vector and/or matrix) of measurement samples across different cells may be obtained for respective location reference points.

The RRM prediction model may be trained based on the fingerprint database. For example, input training data and/or output training data may be generated (e.g., by the network) based on the fingerprint database. The RRM prediction model may be trained to generate predicted RRM information (e.g., one or more predicted RRM measurements and/or predicted ranking information) based on one or more input RRM measurements generated by a UE. In an example, at least some of the predicted RRM information may be associated with a different frequency than the one or more input RRM measurements.

In some embodiments, the RRM prediction model may approximate the function that maps the fingerprints from the high dimensional signal space to coordinates in the plane by interpolating the collected data. The coordinates may be mapped to RSRP estimates in the target frequency of the predicted RRM measurement. Use of the RRM prediction model to predict RRM measurements may have reduced memory requirements compared with calculating location coordinates and RSRP directly from the fingerprint database (e.g., without exploiting an AI/ML model).

In an example, the RRM prediction model may approximate a kernel regression function to predict an RRM measurement. A kernel regression may be used to estimate the conditional expectation of a random variable. For example, the kernel regression may find a non-linear relation between a pair of random variables (e.g., X and Y). In a non-parametric regression, the conditional expectation of a variable Y relative to a variable X may be written as E(Y|X)=m(X), where m is an unknown function. In some embodiments, the function approximated by the RRM prediction model may correspond to:

$$\hat{E} ( Y \vert X = x ) = \int y \frac{\hat{f} ( x , y )}{\hat{f} ( x )} dy = \int y \frac{{Σ}_{i = 1}^{n} {K}_{h} ( x - {x}_{i} ) {K}_{h} ( y - {y}_{i} )}{{Σ}_{j = 1}^{n} {K}_{h} ( x - {x}_{j} )} dy = \frac{{Σ}_{i = 1}^{n} {K}_{h} ( x - {x}_{i} ) \int {K}_{h} ( y - {y}_{i} ) dy}{{Σ}_{j = 1}^{n} {K}_{h} ( x - {x}_{j} )} = \frac{{Σ}_{i = 1}^{n} {K}_{h} ( x - {x}_{i} ) {y}_{i}}{{Σ}_{j = 1}^{n} {K}_{h} ( x - {x}_{j} )} .$$

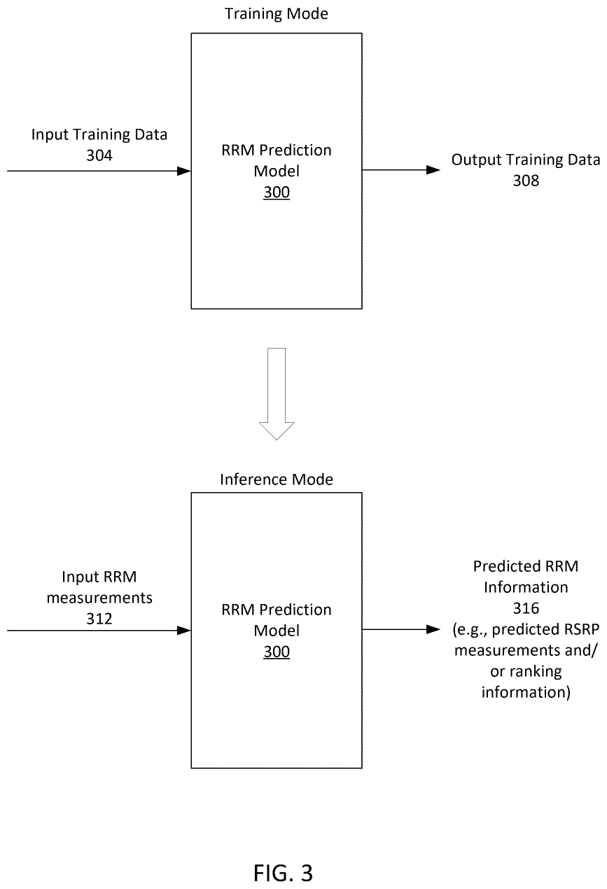

FIG. 3 illustrates an example RRM prediction model 300 in accordance with some embodiments. In an example, the RRM prediction model 300 may be a regression model or a classification model. The RRM prediction model 300 may be trained with input training data 304 and associated output training data 308 (e.g., labeled training data). The input training data 304 may include data for a subset of cell IDs, frequency layers, and/or beams (e.g., transmit beams and/or receive beams) of a training set, such as RSRP values, PMIs, transmit beam indices, and/or codebook information.

In an example (e.g., for a regression model), the output training data may include RSRP values across all cell IDs, frequency layers, and beams (e.g., transmit beams and/or receive beams) of the training set. In another example (e.g., for a classification model), the output training data may include ranking information (e.g., a hot encoding vector) that indicates the best beams, cells, and/or frequencies (e.g., best combinations of (Cell ID (Fᵢ), Tx_{ID}, Rx_{ID})) across all cell IDs, frequency layers, and/or beams of the training set (where Fᵢ corresponds to the frequency layer, Tx_{ID} corresponds to the transmit beam, and Rx_{ID} corresponds to the receive beam).

The input training data 304 and/or output training data 308 may be associated with respective reference locations, as described herein. The input training data 304 and/or output training data 308 may be collected from a plurality of UEs and/or a plurality of reference locations within a geographical area (e.g., that includes the coverage areas of multiple cells).

In inference mode, a UE may generate RRM measurements 312 for a measurement set that includes a subset of cells, frequency layers, and/or beams and provide the RRM measurements 312 to the RRM prediction model 300 as an input. The RRM measurements 312 may include a measurement value, such as RSRP. The RRM measurements 312 may further include information associated with the measurement value, such as frequency layer, cell ID, PMI, and/or beam index (e.g., transmit and/or receive beam index). In some embodiments, the RRM prediction model 300 may further receive a location (e.g., coordinates) of the UE as an input. In other embodiments, the RRM prediction model 300 may perform the inference based on the input RRM measurements without explicit indication of the UE location.

The RRM prediction model 300 may generate predicted RRM information 316 as an output based on the measurement information. The predicted RRM information may be generated for a prediction set that includes one or more cells, frequency layers, and/or beams that are not included in the measurement set. In an example, the predicted RRM information 316 may indicate predicted measurement values (e.g., RSRPs) for respective combinations of (Cell ID (Fᵢ), Tx_{ID}, Rx_{ID}) for respective frequencies Fᵢ of the prediction set (e.g., for a number k of frequencies). For example, the predicted RRM information 316 may include predicted L1 and/or L3 filtered beam-level RSRP measurements for beams of the prediction set.

In another example, the predicted RRM information 316 may include predicted cell-level RSRP measurements (e.g., L3 RSRP) for individual cells of the prediction set. The cell-level RSRP measurements may correspond to the RSRP for the best beam (e.g., transmit beam and/or receive beam) associated with the cell. The beam-level and/or cell-level RSRP predictions may be generated as output in embodiments when the RRM prediction model 300 is trained with output training data 308 that indicates RSRP values, as discussed above (e.g., for a regression model).

In another example, the predicted RRM information 316 may indicate ranking information for the prediction set. For example, the ranking information may include a prediction of the best combinations of (Cell ID (Fᵢ), Tx_{ID}, Rx_{ID}) for the prediction set (e.g., the top n combinations, where n may be configured or predefined). In another example, the ranking information may indicate a prediction of the best frequency layers and associated cell IDs (e.g., best pairs of (Cell ID, frequency)) for the prediction set. In some embodiments, the predicted RRM information 316 may include the ranking information in instances in which the RRM prediction model 300 is trained with output training data 308 that includes ranking information. In some embodiments, the output 316 may include the ranking information in instances in which the RRM prediction model 300 is trained with output training data 308 that includes RSRP values (e.g., with or without also including ranking information).

As described above, the input RRM measurements 312 can be fed to RRM prediction model 300. The RRM prediction model 300 can include one or more learning-based and/or non-learning-based models for perceiving, synthesizing, and inferring information. Persons skilled in the art will appreciate that the RRM prediction model 300 can include any suitable number of processes to generate the predicted RRM information 316 based on the input RRM measurements 312.

Persons of ordinary skill in the art will appreciate that the RRM prediction model 300 can include any suitable machine learning models that are well-known or widely available such as regression techniques, classification techniques, neural networks, and deep learning networks. In instances where the RRM prediction model 300 comprises a machine-learning based model, RRM prediction model 300 can be trained to predict RRM information based on input RRM measurement data using one or more well-known or widely available training techniques such as supervised learning, semi-supervised learning, unsupervised learning, and/or reinforcement learning techniques. The training data can include the aforementioned input training data 304 and/or output training data 308.

As discussed above, training data may be collected from multiple UEs at respective reference locations. However, different UEs may report different RSRP values at the same reference location, e.g., due to hardware variation and/or other factors. Accordingly, use of raw RSRP values in this circumstance may hinder accurate RRM predictions. In some embodiments, the training data and/or training scheme of the RRM prediction model may use differential RSRP values that correspond to a differential signal strength between an associated cell and a reference cell (also referred to as an anchor cell). The use of differential RSRP values may remove and/or reduce measurement variation due to hardware differences.

For example, a UE may perform measurements on two inter-frequency cells, Cell 1 and Cell 2, in respective frequencies F1 and F2. The base stations (e.g., transmission-reception points (TRPs)) that implement Cell 1 and Cell 2 may be at respective distances d1 and d2 from the UE. The received power from Cell 1 for the UE may correspond to:

$$P ( {d}_{1} ) {\vert}_{dB} = 10 {log}_{10} ( \frac{{P}_{{TX}_{1}} {G}_{{cell}_{1}} {G}_{UE} {λ}_{1}^{2}}{16 {π}^{2} {d}_{0}^{2}} ) - β 10 {log}_{10} ( \frac{{d}_{1}}{{d}_{0}} ) + {X}_{1 dB} ,$$

where P_{TX} is a transmission power, G_{cell} is a cell gain, G_{UE} is a UE gain, λ is a wavelength of the cell, d₀ is a reference distance (e.g., 1 meter or another suitable distance), β is a fitting parameter, and X_{1 dB} is a shadowing factor in dB.

The received power from Cell 2 for the UE may correspond to:

$$P ( {d}_{2} ) {\vert}_{dB} = 10 {log}_{10} ( \frac{{P}_{{TX}_{2}} {G}_{{cell}_{2}} {G}_{UE} {λ}_{2}^{2}}{16 {π}^{2} {d}_{0}^{2}} ) - β 10 {log}_{10} ( \frac{{d}_{2}}{{d}_{0}} ) + {X}_{2 dB} ,$$

The UE gain G_{UE} may be different for different UEs, e.g., based on hardware variation. Accordingly, a differential RSRP may be used that removes the dependence on the UE gain. The differential RSRP value for a given cell may be based on a difference of the RSRP value compared with the RSRP value of an anchor/reference cell. For example, a differential RSRP value for Cell 1 with reference to Cell 2 may correspond to:

$$\frac{P ( {d}_{1} )}{P ( {d}_{2} )} {\vert}_{dB} = 10 {log}_{10} ( \frac{{P}_{{TX}_{1}} {G}_{{cell}_{1}} {λ}_{1}^{2}}{{P}_{{TX}_{2}} {G}_{{cell}_{2}} {λ}_{2}^{2}} ) - β 10 {log}_{10} ( \frac{{d}_{1}}{{d}_{2}} ) + {X}_{1 dB} - {X}_{2 dB} .$$

In some embodiments, the UE may report differential RSRP values to the network. The reported differential RSRP values may be used to train the RSRP prediction model. In an example, the report may indicate an ID of the reference/anchor cell and differential RSRP values of other cells with reference to the reference/anchor cell.

Additionally, or alternatively, the UE may provide differential RSRP measurements to the RRM prediction model as input. The RRM prediction model may generate an output based on the differential RSRP measurements.

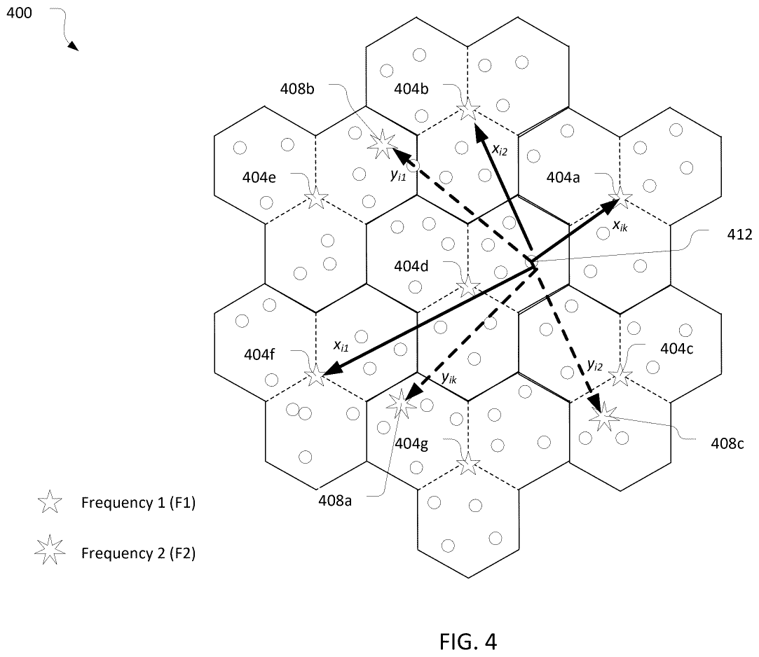

FIG. 4 illustrates an example network environment 400 in accordance with some embodiments. The network environment 400 may include base stations 404a-g that implement cells in a first frequency F1 and base stations 408a-c that implement cells in a second frequency F2. The network environment 400 further includes a plurality of UEs at respective locations, including UE 412.

The UEs may perform RSRP measurements on some or all of the cells implemented by base stations 404a-g and/or 408a-c and transmit the RSRP measurements to the network. The UEs may report the RSRP measurements as differential RSRP measurements or the network may generate differential RSRP measurements based on the reported RSRP measurements. The differential RSRP measurements for UE i may include measurement samples \tilde{x}ᵢ=[\tilde{x}ᵢ₁, . . . , \tilde{x}ᵢ₍ₙ₋₁₎] at frequency F1 (e.g., with n cells) and \tilde{y}ᵢ=[\tilde{y}ᵢ₁, . . . , \tilde{y}ᵢ₍ₙ₋₁₎] at frequency F2, where \tilde{x}ᵢⱼ=xᵢⱼ−xᵢₖ and \tilde{y}ᵢⱼ=yᵢⱼ−yᵢₖ denote the RSRP difference between the j-th site (cell) and the anchor site (cell) k. The set of measurements and associated locations may be referred to as a radio map.

In some embodiments, an individual UE may use the same anchor cell for all differential RSRP measurements of a given frequency layer (e.g., one anchor cell per frequency layer). Different UEs may use different anchor cells or the same anchor cell (e.g., configured by the network).

The network may receive measurements (e.g., radiomaps) for a plurality of UEs at respective locations and generate a fingerprint database based on the differential RSRP measurements. The network may train an RRM prediction model (e.g., AI/ML model) based on the fingerprint database. The RRM prediction model may exploit the data structure and/or dependencies in the database (e.g., \tilde{ŷ}=F(\tilde{x})) to compute a function that estimates the differential RSRPs \tilde{ŷ} from \tilde{x}.

The network may configure the RRM prediction model for (e.g., transmit model parameters to) individual UEs. In some embodiments, individual UEs may fine-tune the RRM prediction model, e.g., for localization.

During inference, the UE may perform one or more RRM measurements at frequency layer F1 (e.g., \tilde{x}). The UE may use the RRM prediction model to predict one or more RRM measurements at frequency layer F2. The RRM prediction model may additionally or alternatively be used to generate predictions across the time domain and/or spatial domain (e.g., different beams).

The use of differential RSRP measurements as described above may provide improved localization accuracy across heterogeneous devices (UEs). In some embodiments, the differential RSRP scheme may be further enhanced by using pairwise differential RSRP values across different pairs of cells rather than a single anchor cell. For example, pairwise differential RSRP values between all combinations of cells (e.g., for a given frequency) may be used to train the RSRP prediction model. Accordingly, with n cell sites, the set of fingerprints may include

$$( \begin{matrix}n \\ 2\end{matrix} ) = \frac{n ( n - 1 )}{2}$$

received signal strength (RSS) differences.

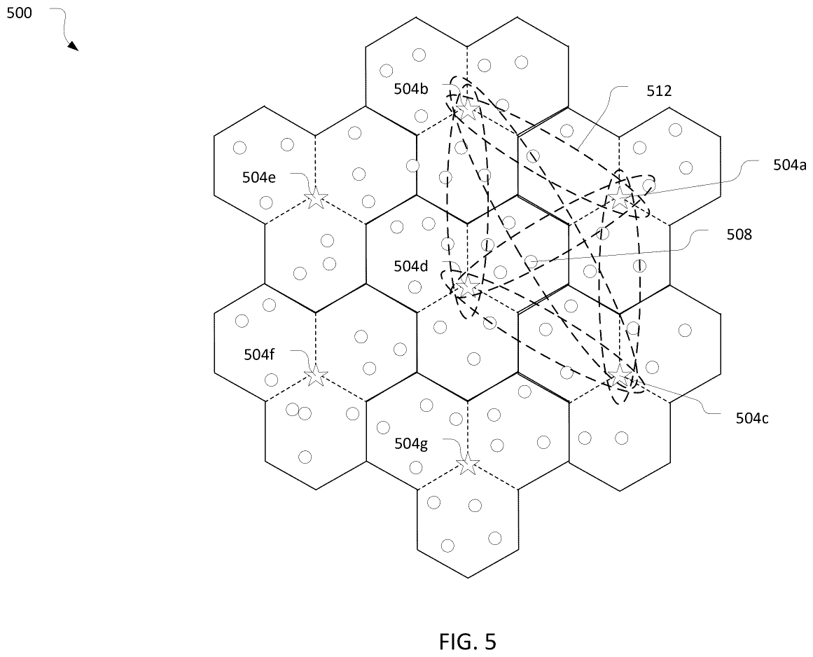

FIG. 5 illustrates an example network environment 500 in accordance with some embodiments. The network environment 500 may include base stations 504a-g that implement respective cells (e.g., in a frequency F1). The network environment 500 further includes a plurality of UEs at respective locations, including UE 508. The UE 508 may generate pairwise differential RSRP measurements for respective pairs of some or all of the base stations 504a-g and/or associated cells. For example, FIG. 5 illustrates pairings 512 for all possible pairings of base stations 504a-d.

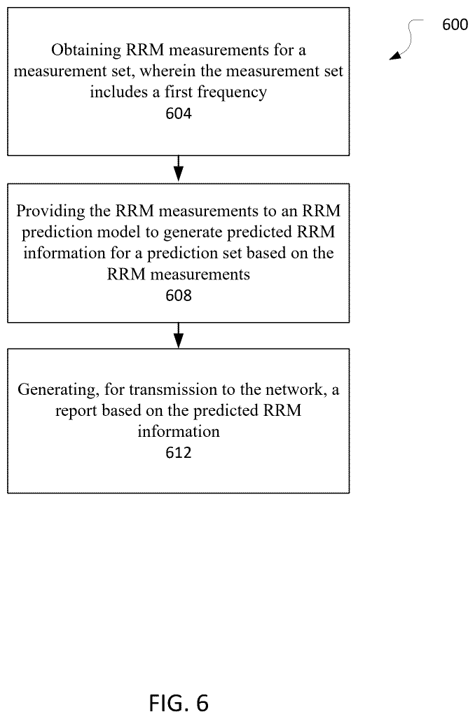

FIG. 6 illustrates an operational flow/algorithmic structure 600 in accordance with some embodiments. In some embodiments, the operational flow/algorithmic structure 600 may be implemented by a UE such as, for example, UE 104, UE 900, or components thereof, for example, processors 904A.

The operational flow/algorithmic structure 600 may further include, at 604, obtaining RRM measurements for the measurement set, wherein the measurement set includes a first frequency. In some embodiments, the UE may receive configuration information from the network to configure the measurement set. The measurement set may include a set of combinations of frequency, cell, transmit beam, and/or receive beam.

The operational flow/algorithmic structure 600 may further include, at 608, providing the RRM measurements to an RRM prediction model to generate predicted RRM information for a prediction set based on the RRM measurements. The prediction set may include combinations of frequency, cell, transmit beam, and/or receive beam, and may include at least one combination that is not included in the measurement set. For example, the RRM prediction model may perform inter-frequency RRM predictions. Accordingly, the measurement set may include a first frequency and the prediction set may include a second frequency that is not included in the measurement set.

In an example, the predicted RRM information includes predicted RSRP measurements for respective combinations of cell ID, transmit beam, and/or receive beam for the second frequency. In another example, the predicted RRM information includes L3 RSRP values for respective cells. In another example, the predicted RRM information includes ranking information that indicates pairs of cell ID and associated beam information that have a highest ranking among the prediction set. In another example, the predicted RRM information indicates cell IDs and associated frequencies that have a highest ranking among the prediction set.

The operational flow/algorithmic structure 600 may further include, at 612, generating, for transmission to the network, a report based on the predicted RRM information. For example, the report may include a measurement report, a handover request, and/or another suitable type of report. In other embodiments, the UE may perform a conditional handover based on the predicted RRM information.

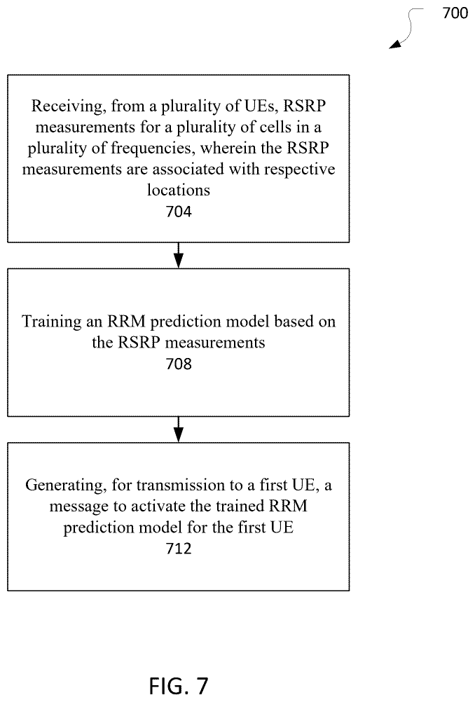

FIG. 7 illustrates another operational flow/algorithmic structure 700 in accordance with some embodiments. In some embodiments, the operational flow/algorithmic structure 700 may be implemented by a network device, such as a base station (e.g., base station 108), network device 1000, or components thereof, for example, processors 1004A.

The operational flow/algorithmic structure 700 may include, at 704, receiving, from a plurality of UEs, RSRP measurements for a plurality of cells in a plurality of frequencies, wherein the RSRP measurements are associated with respective locations. In an example, the RSRP measurements may include differential RSRP measurements for respective cells. In an example, the differential RSRP measurements may be reference to a designated anchor cell. For example, for n cells, the differential RSRP measurements may include n−1 reported differential RSRPs (e.g., a differential RSRP measurement for each cell other than the anchor cell with reference to the anchor cell). In another example, the differential RSRP measurements may be pairwise differential measurements for respective pairs of cells among a set of cells (e.g., including three or more cells). In some embodiments, a UE may report pairwise differential measurements for all pair combinations or a subset of pair combinations in the set of cells. Different pairwise differential measurements may be with reference to different cells.

The operational flow/algorithmic structure 700 may further include, at 708, training an RRM prediction model based on the RSRP measurements. For example, the network may generate input training data and associated output training data based on the RSRP measurements. The input training data and output training data may be as described with respect to FIG. 3. For example, the input training data may include RSRP measurements associated with a first frequency. The output training data may include RSRP measurements and/or ranking information associated with a second frequency.

The operational flow/algorithmic structure 700 may further include, at 712, generating, for transmission to a first UE, a message to activate the trained RRM prediction model for the first UE. For example, the trained RRM prediction model may enable the first UE to perform inter-frequency RRM predictions based on the trained RRM prediction model. In an example, the message may include model parameters to configure the trained RRM prediction model for the first UE.

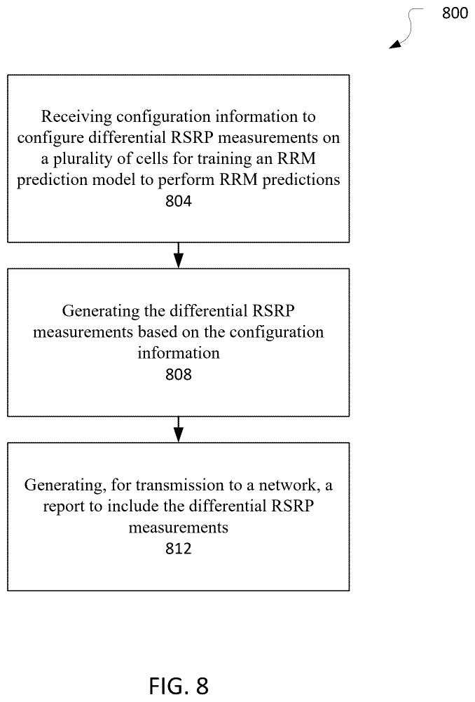

FIG. 8 illustrates an operational flow/algorithmic structure 800 in accordance with some embodiments. In some embodiments, the operational flow/algorithmic structure 800 may be implemented by a UE such as, for example, UE 104, UE 900, or components thereof, for example, processors 904A.

The operational flow/algorithmic structure 800 may include, at 804, receiving configuration information to configure differential RSRP measurements on a plurality of cells for training an RRM prediction model to perform RRM predictions. For example, the configuration information may indicate measurement resources (e.g., CSI-RS resources and/or SSB resources) on which the UE is to perform RSRP measurements. In another example, the configuration information may indicate one or more parameters for the differential RSRP measurements, such as a type of differential measurement (e.g., with respect to a single reference cell or pairwise measurements with different reference cells), and/or a precision (e.g., bit depth) of reported measurements.

The operational flow/algorithmic structure 800 may further include, at 808, generating the differential RSRP measurements based on the configuration information. In an example, the differential RSRP measurements may be reference to a designated anchor cell. For example, for n cells, the differential RSRP measurements may include n−1 reported differential RSRPs (e.g., a differential RSRP measurement for each cell other than the anchor cell with reference to the anchor cell). In another example, the differential RSRP measurements may be pairwise differential measurements for respective pairs of cells among a set of cells (e.g., including three or more cells). In some embodiments, a UE may report pairwise differential measurements for all pair combinations or a subset of pair combinations in the set of cells. Different pairwise differential measurements may be with reference to different cells.

The operational flow/algorithmic structure 800 may further include, at 812, generating, for transmission to a network, a report to include the differential RSRP measurements.

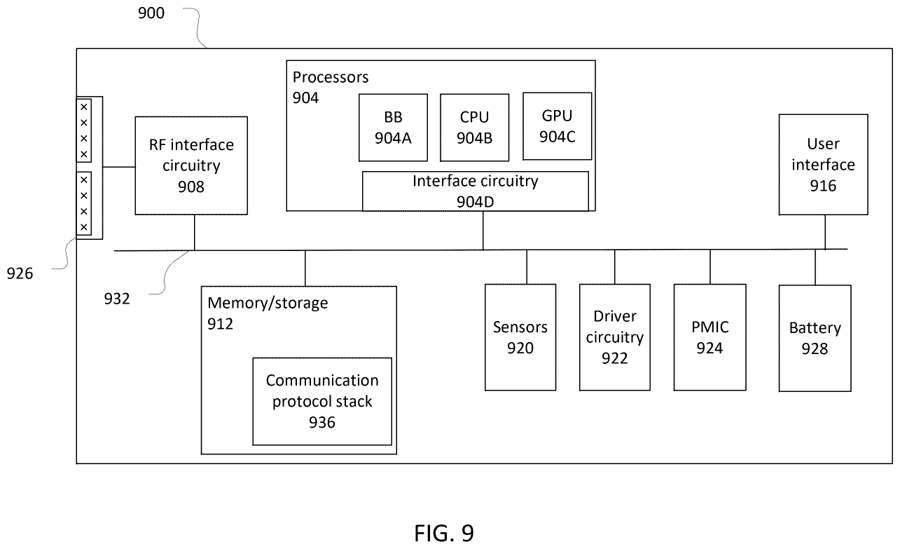

FIG. 9 illustrates a UE 900 in accordance with some embodiments. The UE 900 may be similar to and substantially interchangeable with UE 104.

The UE 900 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, or actuators), video surveillance/monitoring devices (for example, cameras or video cameras), wearable devices (for example, a smart watch), or Internet-of-things devices.

The UE 900 may include processors 904, RF interface circuitry 908, memory/storage 912, user interface 916, sensors 920, driver circuitry 922, power management integrated circuit (PMIC) 924, antenna 926, and battery 928. The components of the UE 900 may be implemented as integrated circuits (ICs), portions thereof, discrete electronic devices, or other modules, logic, hardware, software, firmware, or a combination thereof. In some embodiments, processor 1604 may include RF interface circuitry 1608. The block diagram of FIG. 9 is intended to show a high-level view of some of the components of the UE 900. However, some of the components shown may be omitted, additional components may be present, and different arrangement of the components shown may occur in other implementations.

The components of the UE 900 may be coupled with various other components over one or more interconnects 932, which may represent any type of interface, input/output, bus (local, system, or expansion), transmission line, trace, or optical connection that allows various circuit components (on common or different chips or chipsets) to interact with one another.

The processors 904 may include processor circuitry such as, for example, baseband processor circuitry (BB) 904A, central processor unit circuitry (CPU) 904B, and graphics processor unit circuitry (GPU) 904C. The processors 904 may include any type of circuitry or processor circuitry that executes or otherwise operates computer-executable instructions, such as program code, software modules, or functional processes from memory/storage 912 to cause the UE 900 to perform operations as described herein (e.g., operations associated with RRM prediction, including training and/or implementing an RRM prediction model). The processors 904 may also include interface circuitry 904D to enable communication by, for example, communicatively coupling the processor circuitry with one or more other components of the UE 900.

In some embodiments, the baseband processor 904A may access a communication protocol stack 936 in the memory/storage 912 to communicate over a 3GPP compatible network. In general, the baseband processor 904A may access the communication protocol stack 936 to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a NAS layer. In some embodiments, the PHY layer operations may additionally/alternatively be performed by the components of the RF interface circuitry 908.

The baseband processor 904A may generate or process baseband signals or waveforms that carry information in 3GPP-compatible networks. In some embodiments, the waveforms for NR may be based on cyclic prefix OFDM (CP-OFDM) in the uplink or downlink, and discrete Fourier transform spread OFDM (DFT-S-OFDM) in the uplink.

The memory/storage 912 may include one or more non-transitory, computer-readable media that includes instructions (for example, communication protocol stack 936) that may be executed by one or more of the processors 904 to cause the UE 900 to perform operations as described herein (e.g., operations associated with RRM prediction, including training and/or implementing an RRM prediction model).

The memory/storage 912 includes any type of volatile or non-volatile memory that may be distributed throughout the UE 900. In some embodiments, some of the memory/storage 912 may be located on the processors 904 themselves (for example, memory/storage 912 may be part of a chipset that corresponds to the baseband processor 904A), while other memory/storage 912 is external to the processors 904 but accessible thereto via a memory interface. The memory/storage 912 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 908 may include transceiver circuitry and a radio frequency front module (RFEM) that allows the UE 900 to communicate with other devices over a radio access network. The RF interface circuitry 908 may include various elements arranged in transmit or receive paths. These elements may include, for example, switches, mixers, amplifiers, filters, synthesizer circuitry, and control circuitry.

In the receive path, the RFEM may receive a radiated signal from an air interface via antenna 926 and proceed to filter and amplify (with a low-noise amplifier) the signal. The signal may be provided to a receiver of the transceiver that down-converts the RF signal into a baseband signal that is provided to the baseband processor of the processors 904.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 926.

In various embodiments, the RF interface circuitry 908 may be configured to transmit/receive signals in a manner compatible with NR access technologies.

The antenna 926 may include antenna elements to convert electrical signals into radio waves to travel through the air and to convert received radio waves into electrical signals. The antenna elements may be arranged into one or more antenna panels. The antenna 926 may have antenna panels that are omnidirectional, directional, or a combination thereof to enable beamforming and multiple input, multiple output communications. The antenna 926 may include microstrip antennas, printed antennas fabricated on the surface of one or more printed circuit boards, patch antennas, or phased array antennas. The antenna 926 may have one or more panels designed for specific frequency bands including bands in FR1 or FR2.

The user interface 916 includes various input/output (I/O) devices designed to enable user interaction with the UE 900. The user interface 916 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, and projectors), with the output of characters, graphics, multimedia objects, and the like being generated or produced from the operation of the UE 900.

The sensors 920 may include devices, modules, or subsystems whose purpose is to detect events or changes in their environment and send the information (sensor data) about the detected events to some other device, module, or subsystem. Examples of such sensors include inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; and microphones or other like audio capture devices.

The driver circuitry 922 may include software and hardware elements that operate to control particular devices that are embedded in the UE 900, attached to the UE 900, or otherwise communicatively coupled with the UE 900. The driver circuitry 922 may include individual drivers allowing other components to interact with or control various input/output (I/O) devices that may be present within, or connected to, the UE 900. For example, driver circuitry 922 may include a display driver to control and allow access to a display device, a touchscreen driver to control and allow access to a touchscreen interface, sensor drivers to obtain sensor readings of sensors 920 and control and allow access to sensors 920, drivers to obtain actuator positions of electro-mechanic components or control and allow access to the electro-mechanic components, a camera driver to control and allow access to an embedded image capture device, audio drivers to control and allow access to one or more audio devices.

The PMIC 924 may manage power provided to various components of the UE 900. In particular, with respect to the processors 904, the PMIC 924 may control power-source selection, voltage scaling, battery charging, or DC-to-DC conversion.

A battery 928 may power the UE 900, although in some examples the UE 900 may be mounted deployed in a fixed location and may have a power supply coupled to an electrical grid. The battery 928 may be a lithium ion battery, a metal-air battery, such as a zinc-air battery, an aluminum-air battery, a lithium-air battery, and the like. In some implementations, such as in vehicle-based applications, the battery 928 may be a typical lead-acid automotive battery.

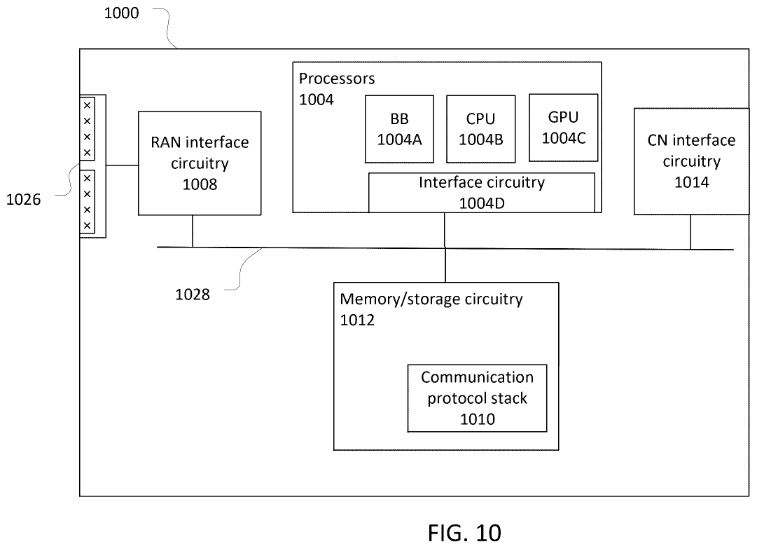

FIG. 10 illustrates a network device 1000 in accordance with some embodiments. The network device 1000 may be similar to, and substantially interchangeable with, the base station 108 and/or a component of the CN 112.

The network device 1000 may include processors 1004, RF interface circuitry 1008 (if implemented as a base station), core network (CN) interface circuitry 1014, memory/storage circuitry 1012, and antenna structure 1026.

The components of the network device 1000 may be coupled with various other components over one or more interconnects 1028.

The processors 1004, RF interface circuitry 1008, memory/storage circuitry 1012 (including communication protocol stack 1010), antenna structure 1026, and interconnects 1028 may be similar to like-named elements shown and described with respect to FIG. 9.

The processors 1004 may include processor circuitry such as, for example, baseband processor circuitry (BB) 1004A, central processor unit circuitry (CPU) 1004B, and graphics processor unit circuitry (GPU) 1004C. The processors 1004 may include any type of circuitry or processor circuitry that executes or otherwise operates computer-executable instructions, such as program code, software modules, or functional processes from memory/storage circuitry 1012 to cause the network device 1000 to perform operations as described herein (e.g., operations associated with RRM prediction, including training and/or implementing an RRM prediction model). The processors 1004 may also include interface circuitry 1004D to communicatively couple the processor circuitry with one or more other components of the network device 1000.

The CN interface circuitry 1014 may provide connectivity to a core network, for example, a 5th Generation Core network (5GC) using a 5GC-compatible network interface protocol such as carrier Ethernet protocols, or some other suitable protocol. Network connectivity may be provided to/from the network device 1000 via a fiber optic or wireless backhaul. The CN interface circuitry 1014 may include one or more dedicated processors or FPGAs to communicate using one or more of the aforementioned protocols. In some implementations, the CN interface circuitry 1014 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, or network element as described above in connection with one or more of the preceding figures may be configured to operate in accordance with one or more of the examples set forth below in the example section.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Some embodiments described herein can include use of learning and/or non-learning-based process(es). The use can include collecting, pre-processing, encoding, labeling, organizing, analyzing, recommending and/or generating data. Entities that collect, share, and/or otherwise utilize user data should provide transparency and/or obtain user consent when collecting such data. The present disclosure recognizes that the use of the data in the RRM prediction processes can be used to benefit users.

For example, the data can be used to train models that can be deployed to improve performance, accuracy, and/or functionality of applications and/or services. Accordingly, the use of the data enables the RRM prediction processes to adapt and/or optimize operations to provide more personalized, efficient, and/or enhanced user experiences. Such adaptation and/or optimization can include tailoring content, recommendations, and/or interactions to individual users, as well as streamlining processes, and/or enabling more intuitive interfaces. Further beneficial uses of the data in the RRM prediction processes are also contemplated by the present disclosure.

The present disclosure contemplates that, in some embodiments, data used by the RRM prediction processes includes publicly available data. To protect user privacy, data may be anonymized, aggregated, and/or otherwise processed to remove or to the degree possible limit any individual identification. As discussed herein, entities that collect, share, and/or otherwise utilize such data should obtain user consent prior to and/or provide transparency when collecting such data. Furthermore, the present disclosure contemplates that the entities responsible for the use of data, including, but not limited to data used in association with the RRM prediction processes, should attempt to comply with well-established privacy policies and/or privacy practices.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, or network element as described above in connection with one or more of the preceding figures may be configured to operate in accordance with one or more of the examples set forth below in the example section.

### EXAMPLES

The following sections provide further exemplary embodiments are provided.

Example 1 includes a method comprising: receiving, from a network, configuration information for a measurement set; obtaining radio resource monitoring (RRM) measurements for the measurement set, wherein the measurement set includes a first frequency; providing the RRM measurements to an RRM prediction model to generate predicted RRM information for a prediction set based on the RRM measurements, wherein the prediction set includes a second frequency that is not included in the measurement set; and generating, for transmission to the network, a report based on the predicted RRM information.

Example 2 includes the method of example 1, wherein the predicted RRM information includes predicted reference signal received power (RSRP) measurements for respective combinations of cell ID, transmit beam, and receive beam for the second frequency.

Example 3 includes the method of example 1, wherein the predicted RRM information includes layer 3 (L3) RSRP values for respective cells.

Example 4 includes the method of example 1, wherein the predicted RRM information includes ranking information that indicates pairs of cell ID and associated beam information that have a highest ranking among the prediction set.

Example 5 includes the method of example 1, wherein the predicted RRM information indicates cell IDs and associated frequencies that have a highest ranking among the prediction set.

Example 6 includes the method of example 1, further comprising: generating one or more reference signal received power (RSRP) measurements on respective cells; and reporting the one or more RSRP measurements to the network for training the RRM prediction model.

Example 7 includes the method of example 6, wherein the one or more RSRP measurements include differential RSRP measurements for respective cells.

Example 8 includes the method of example 7, wherein the differential RSRP measurements are with reference to an anchor cell.

Example 9 includes the method of example 7, wherein the one or more differential RSRP measurements are pairwise differential measurements for respective pairs of cells among a set of three or more cells.

Example 10 includes the method of example 6, further comprising reporting a location associated with the one or more RSRP measurements.

Example 11 includes a method comprising: receiving, from a plurality of user equipments (UEs), reference signal received power (RSRP) measurements for a plurality of cells in a plurality of frequencies, wherein the RSRP measurements are associated with respective locations; training a radio resource monitoring (RRM) prediction model based on the RSRP measurements; and generating, for transmission to a first UE, a message to activate the trained RRM prediction model to enable the first UE to perform inter-frequency RRM predictions based on the trained RRM prediction model.

Example 12 includes the method of example 11, wherein the RSRP measurements include differential RSRP measurements for respective cells.

Example 13 includes the method of example 12, wherein the differential RSRP measurements are with reference to an anchor cell.

Example 14 includes the method of example 12, wherein the differential RSRP measurements are pairwise differential measurements for respective pairs of cells among a set of three or more cells.

Example 15 includes the method of example 11, wherein the RSRP measurements are associated with respective beams of the respective cells.

Example 16 includes processing circuitry to: receive configuration information to configure differential reference signal received power (RSRP) measurements on a plurality of cells for training a radio resource monitoring (RRM) prediction model to perform RRM predictions; generate the differential RSRP measurements based on the configuration information; and generate, for transmission to a network, a report to include the differential RSRP measurements. In some embodiments, example 16 may further include interface circuitry coupled to the processing circuitry to enable communication.

Example 17 includes the processing circuitry of example 16, wherein the differential RSRP measurements are with reference to an anchor cell.

Example 18 includes the processing circuitry of example 16, wherein the plurality of cells includes three or more cells, and wherein the differential RSRP measurements includes pairwise differential measurements for respective pairs of cells among the three or more cells.

Example 19 includes the processing circuitry of example 16, wherein the report indicates a location associated with the differential RSRP measurements.

Example 20 includes the processing circuitry of example 16, wherein the differential RSRP measurements include differential RSRP measurements associated with different frequencies and wherein the RRM prediction model is to be trained to perform inter-frequency RRM predictions.

Example 21 includes the processing circuitry of example 16, wherein the processing circuitry is further to: obtain RRM measurements associated with a first frequency; provide the RRM measurements to the RRM prediction model; obtain, from the RRM prediction model based on the RRM measurements, predicted RRM information associated with a second frequency; and generate, for transmission to the network, a report based on the predicted RRM information.

Another example may include an apparatus comprising means to perform one or more elements of a method described in or related to any of examples 1-21, or any other method or process described herein.

Another example may include one or more non-transitory computer-readable media comprising instructions to cause an electronic device, upon execution of the instructions by one or more processors of the electronic device, to perform one or more elements of a method described in or related to any of examples 1-21, or any other method or process described herein.

Another example may include an apparatus comprising logic, modules, or circuitry to perform one or more elements of a method described in or related to any of examples 1-21, or any other method or process described herein.

Another example may include a method, technique, or process as described in or related to any of examples 1-21, or portions or parts thereof.

Another example may include an apparatus comprising: one or more processors and one or more computer-readable media comprising instructions that, when executed by the one or more processors, cause the one or more processors to perform the method, techniques, or process as described in or related to any of examples 1-21, or portions thereof.

Another example may include a signal as described in or related to any of examples 1-21, or portions or parts thereof.

Another example may include a datagram, information element, packet, frame, segment, PDU, or message as described in or related to any of examples 1-21, or portions or parts thereof, or otherwise described in the present disclosure.

Another example may include a signal encoded with data as described in or related to any of examples 1-21, or portions or parts thereof, or otherwise described in the present disclosure.

Another example may include a signal encoded with a datagram, IE, packet, frame, segment, PDU, or message as described in or related to any of examples 1-21, or portions or parts thereof, or otherwise described in the present disclosure.

Another example may include an electromagnetic signal carrying computer-readable instructions, wherein execution of the computer-readable instructions by one or more processors is to cause the one or more processors to perform the method, techniques, or process as described in or related to any of examples 1-21, or portions thereof.

Another example may include a computer program comprising instructions, wherein execution of the program by a processing element is to cause the processing element to carry out the method, techniques, or process as described in or related to any of examples 1-21, or portions thereof.

Another example may include a signal in a wireless network as shown and described herein.

Another example may include a method of communicating in a wireless network as shown and described herein.

Another example may include a system for providing wireless communication as shown and described herein.

Another example may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method comprising:
receiving, from a network, configuration information for a measurement set;
obtaining radio resource monitoring (RRM) measurements for the measurement set, wherein the measurement set includes a first frequency;
providing the RRM measurements to an RRM prediction model to generate predicted RRM information for a prediction set based on the RRM measurements, wherein the prediction set includes a second frequency that is not included in the measurement set; and
generating, for transmission to the network, a report based on the predicted RRM information.

2. The method of claim 1, wherein the predicted RRM information includes predicted reference signal received power (RSRP) measurements for respective combinations of cell ID, transmit beam, and receive beam for the second frequency.

3. The method of claim 1, wherein the predicted RRM information includes layer 3 (L3) RSRP values for respective cells.

4. The method of claim 1, wherein the predicted RRM information includes ranking information that indicates pairs of cell ID and associated beam information that have a highest ranking among the prediction set.

5. The method of claim 1, wherein the predicted RRM information indicates cell IDs and associated frequencies that have a highest ranking among the prediction set.

6. The method of claim 1, further comprising:
generating one or more reference signal received power (RSRP) measurements on respective cells; and
reporting the one or more RSRP measurements to the network for training the RRM prediction model.

7. The method of claim 6, wherein the one or more RSRP measurements include differential RSRP measurements for respective cells.

8. The method of claim 7, wherein the differential RSRP measurements are with reference to an anchor cell.

9. The method of claim 7, wherein the one or more differential RSRP measurements are pairwise differential measurements for respective pairs of cells among a set of three or more cells.

10. The method of claim 6, further comprising reporting a location associated with the one or more RSRP measurements.

11. A method comprising:
receiving, from a plurality of user equipments (UEs), reference signal received power (RSRP) measurements for a plurality of cells in a plurality of frequencies, wherein the RSRP measurements are associated with respective locations;
training a radio resource monitoring (RRM) prediction model based on the RSRP measurements; and
generating, for transmission to a first UE, a message to activate the trained RRM prediction model to enable the first UE to perform inter-frequency RRM predictions based on the trained RRM prediction model.

12. The method of claim 11, wherein the RSRP measurements include differential RSRP measurements for respective cells.

13. The method of claim 12, wherein the differential RSRP measurements are with reference to an anchor cell.

14. The method of claim 12, wherein the differential RSRP measurements are pairwise differential measurements for respective pairs of cells among a set of three or more cells.

15. The method of claim 11, wherein the RSRP measurements are associated with respective beams of the respective cells.

16. An apparatus comprising:
processing circuitry to:
receive configuration information to configure differential reference signal received power (RSRP) measurements on a plurality of cells for training a radio resource monitoring (RRM) prediction model to perform RRM predictions;
generate the differential RSRP measurements based on the configuration information; and
generate, for transmission to a network, a report to include the differential RSRP measurements; and
interface circuitry coupled to the processing circuitry to enable communication.

17. The apparatus of claim 16, wherein the differential RSRP measurements are with reference to an anchor cell; or
wherein the plurality of cells includes three or more cells and the differential RSRP measurements includes pairwise differential measurements for respective pairs of cells among the three or more cells.

18. The apparatus of claim 16, wherein the report indicates a location associated with the differential RSRP measurements.

19. The apparatus of claim 16, wherein the differential RSRP measurements include differential RSRP measurements associated with different frequencies and wherein the RRM prediction model is to be trained to perform inter-frequency RRM predictions.

20. The apparatus of claim 16, wherein the processing circuitry is further to:
obtain RRM measurements associated with a first frequency;
provide the RRM measurements to the RRM prediction model;
obtain, from the RRM prediction model based on the RRM measurements, predicted RRM information associated with a second frequency; and
generate, for transmission to the network, a report based on the predicted RRM information.
